(19) United States
(12) Patent Application Publication
(10) Pub. No.: US 2019/0237885 A1
(43) Pub. Date: Aug. 1, 2019

(54) WIRING CONNECTOR, FLEXIBLE PRINTED CIRCUIT, TOUCH PANEL, AND DISPLAY DEVICE

(71) Applicants: BOE Technology Group Co., Ltd., Beijing (CN); Ordos Yuansheng Optoelectronics Co., Ltd., Inner Mongolia (CN)

(72) Inventors: Wei ZHANG, Beijing (CN); Runfei DU, Beijing (CN); Cuie WANG, Beijing (CN); Hui LI, Beijing (CN); Wenlong ZHANG, Beijing (CN); Yezhou FANG, Beijing (CN); Jonguk KWAK, Beijing (CN); Tianlei SHI, Beijing (CN)

(21) Appl. No.: 15/758,571

(22) PCT Filed: Sep. 21, 2017
(86) PCT No.: PCT/CN2017/102789

§ 371 Date: Mar. 8, 2018

(30) Foreign Application Priority Data
Mar. 21, 2017 (CN) 201720277465.0

(51) Int. Cl. H01R 12/77; H01R 13/40; H01R 13/639

(52) U.S. Cl. CPC H01R 12/771; H01R 13/6392; H01R 12/778; H01R 13/40

(57) ABSTRACT

Embodiments of this disclosure provide a wiring connector, a flexible printed circuit, a touch panel, and a display device, and the wiring connector includes: a male joint including a first body, first lead terminals arranged on the first body, and two grooves arranged on the first body along an arrangement direction of the first lead terminals; and a female joint including a second body, second lead terminals arranged on the second body, and two clamp structures installed on the second body, wherein the second lead terminals can be socketed respectively with the first lead terminals; and when the second lead terminals are socketed respectively with the first lead terminals, the two clamp structures clamp respectively into the two grooves on the first body.

This application claims the benefit of Chinese Patent Application No. 201720277465.0, filed with the Chinese Patent Office on Mar. 21, 2017, and entitled “A wiring connector, a flexible printed circuit, a touch panel, and a display device”, the content of which is hereby incorporated by reference in its entirety.

### FIELD

Embodiments of this disclosure relate to the field of wiring connectors, and particularly to a wiring connector, a flexible printed circuit, a touch panel, and a display device.

### BACKGROUND

In a display panel, modular structures in a Flexible Printed Circuit (FPC) need to be connected using connectors in the circuit as required for a design of the circuit.

In the related art, a connector generally includes two components, which are a male joint and a female joint; and lead terminals of the male joint are socketed with lead terminals of the female joint, and both of them are compacted by a cover, so that the lead terminals of the male joint can be fixed with the lead terminals of the female joint, and thus wires in the flexible printed circuit can be connected with each other. However in a real application, the lead terminals of the male and female joints of the connector tend to fail to be socketed in place with each other, so the connection in the circuit tends to fail, and thus a touch function, a display function, etc., of a display module fails.

### SUMMARY

At least one embodiment of this disclosure provides a wiring connector including: a male joint including a first body, first lead terminals arranged on the first body, and two grooves arranged on the first body along an arrangement direction of the first lead terminals; and a female joint including a second body, second lead terminals arranged on the second body, and two clamp structures installed on the second body, wherein the second lead terminals can be socketed respectively with the first lead terminals; and when the second lead terminals are socketed respectively with the first lead terminals, the two clamp structures clamp respectively into the two grooves on the first body.

In some embodiment of this disclosure, the two grooves are arranged symmetrically on two ends of the first body.

In some embodiment of this disclosure, each clamp structure includes: an extension section extending along a direction perpendicular to the arrangement direction of the second lead terminals, wherein the extension section is fixed on the second body, and has a part thereof extending out of the second body; and a clamp section fixed on one end, of the extension section, extending out of the second body, wherein the clamp section can clamp into a groove matching therewith.

In some embodiment of this disclosure, the clamp section is a ball-head structure; a diameter of a ball head is larger than a radical size of the extension section; and the grooves are arc-shaped grooves.

In some embodiment of this disclosure, the clamp section is a hook-shaped structure; hook-shaped sections of the two clamp structures are arranged opposite to each other; and the grooves are square- or trapezoid-shaped grooves.

In some embodiment of this disclosure, the clamp structures are integral structures.

In some embodiment of this disclosure, the clamp structures are made of an elastic material.

At least one embodiment of this disclosure provides a flexible printed circuit including the wiring connector according to any one of the embodiments above.

At least one embodiment of this disclosure provides a touch panel including the wiring connector according to any one of the embodiments above.

At least one embodiment of this disclosure provides a display device including the wiring connector according to any one of the embodiments above.

### BRIEF DESCRIPTION OF THE DRAWINGS

In order to make the technical solutions in the embodiments of this disclosure more apparent, the drawings to which reference is made in the description of the embodiments will be introduced below in brief, and apparently the drawings to be described below are merely illustrative of some embodiments of this disclosure. Those ordinarily can drive from these drawings other drawings without any inventive effort. In the drawings:

FIG. 1 is a schematic structural diagram of a wiring connector according to an embodiment of this disclosure;

FIG. 2 is a schematic structural diagram of the wiring connector in FIG. 1 in an exploded view;

FIG. 3 is a schematic structural diagram of a wiring connector according to another embodiment of this disclosure; and

FIG. 4 is a schematic structural diagram of the wiring connector in FIG. 3 in an exploded view.

### DETAILED DESCRIPTION OF THE EMBODIMENTS

In order to make the objects, technical solutions, and advantages of the embodiments of this disclosure more apparent, the technical solutions according to the embodiments of this disclosure will be described below clearly and fully with reference to the drawings in the embodiments of this disclosure. Apparently the embodiments to be described are only a part but all of the embodiments of this disclosure. Based upon the embodiments here of this disclosure, all of other embodiments which can occur to those ordinarily skilled in the art without any inventive effort shall come into the scope of this disclosure as claimed.

As illustrated in FIG. 1 to FIG. 4, a wiring connector according to an embodiment of this disclosure includes the following components.

A male joint 1 includes a first body 11, first lead terminals 12 arranged on the first body 11, and two grooves 3 arranged on the first body 11 along the arrangement direction of the first lead terminals 12.

A female joint 2 includes a second body 21, second lead terminals 22 arranged on the second body 21, and two clamp structures 4 installed on the second body 21, where the second lead terminals 22 can be socketed respectively with the first lead terminals 12; and when the second lead terminals 22 are socketed respectively with the first lead terminals 12, the two clamp structures 4 clamp respectively into the two grooves 3 on the first body 11.

In the wiring connector above, there are the two grooves 3 arranged on the first body 11 of the male joint 1, along the direction perpendicular to the arrangement direction of the first lead terminals 12, and correspondingly there are the two clamp structures 4 arranged on the second body 21 of the female joint 2, along the direction perpendicular to the arrangement direction of the second lead terminals 22. When the first lead terminals 12 of the male joint 1 are socketed respectively with the second lead terminals 22 of the female joint 2, the two clamp structures 4 of the female joint 2 can clamp respectively into the two grooves 3 on the first body 11. The two clamp structures 4 clamp into the two grooves 3 matching therewith so that the first body 11 of the male joint 1 can be socketed in place with the second body 21 of the female joint 2, to thereby avoid the problem in the wiring connector that the first lead terminals 12 fail to be socketed in place with the second lead terminals 22. Accordingly the wiring connector can be highly reliable.

As illustrated in FIG. 1 to FIG. 4, in a particular embodiment, the two grooves 3 on the first body 11 of the male joint 1 are arranged symmetrically on two ends of the first body 11; and furthermore when the two clamp structures 4 of the female joint 2 clamp into the two grooves 3 matching therewith, the two clamp structures 4 of the female joint 2 can clamp the first body 11 of the male joint 1 to thereby improve the reliability of the connection between the male joint 1 and the female joint 2, so as to avoid the male joint 1 from falling out of or being disconnected from the female joint 2.

As illustrated in FIG. 1 to FIG. 4, further to the embodiment above, in a particular embodiment, each clamp structure 4 in the female joint 2 can include the following components.

An extension section 41 extends along the direction perpendicular to the arrangement direction of the second lead terminals 22, where the extension section 41 is fixed on the second body 21 and has a part thereof extending out of the second body 21. A clamp section 42 fixed on one end, of the extension section 41, extending out of the second body 21, where the clamp section 42 can clamp into a groove 3 matching therewith.

When the first lead terminals 12 on the first body 11 are socketed with the second lead terminals 22 on the second body 21, the first body 11 can be inserted between the two clamp structures 4 extending out of the second body 21. When the clamp sections 41 of the two clamp structures 4 are embedded respectively into the two grooves 3 on two end faces 10 of the first body 11 and clamp into the grooves 3, it can be determined that the first lead terminals 12 have been socketed in place with the second lead terminals 22 so that they cooperate with, instead of being displaced from, each other.

As illustrated in FIG. 1 to FIG. 4, further to the embodiment above, furthermore the spacing between extension sections 41 of the two clamp structures 4 can be equal to the distance between the two end faces 10 of the first body 11, or can be less than the distance between the two end faces 10 of the first body 11, that is, there is some tolerance. Furthermore when the first body 11 is socketed and cooperates with the second body 21, the extension sections 41 of the two clamp structures 4 can clamp the first body 11 to thereby improve the reliability of the connection between the male joint 1 and the female joint 2, so as to avoid the male joint 1 from falling out of or being disconnected from the female joint 2.

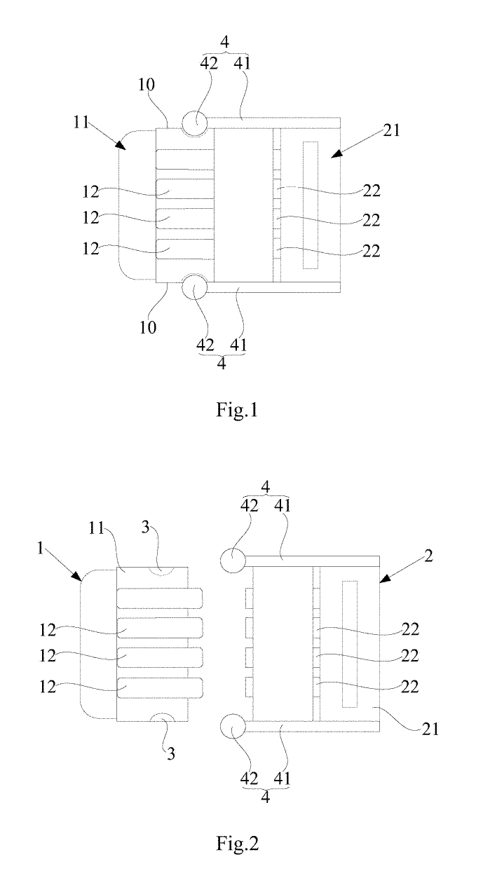

As illustrated in FIG. 1 and FIG. 2, further to the two embodiments above, in a particular embodiment, the clamp sections 42 of the clamp structures 4 can be designed in ball-head structures, and particularly the diameter of a ball head is larger than the radical size of an extension section 41, i.e., the size of a cross section thereof. Furthermore the grooves 3 can be arc-shaped grooves to thereby facilitate clamp matching thereof with the ball-head structures.

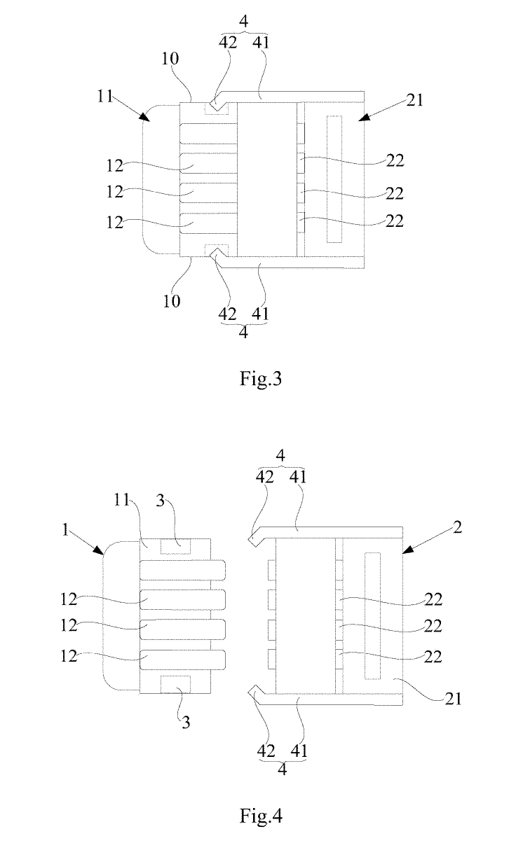

As illustrated in FIG. 3 and FIG. 4, in another particular embodiment, the clamp sections 42 of the clamp structures 4 can alternatively be designed in hook-shaped structures, and particularly the hook-shaped sections of the two clamp structures 4 are arranged opposite to each other; and furthermore the grooves 3 can be square-shaped or trapezoid-shaped grooves to thereby facilitate clamp matching thereof with the hook-shaped structures.

As illustrated in FIG. 1 to FIG. 4, further to the respective embodiments above, in a particular embodiment, the clamp structures 4 can be integral structures.

Furthermore the clamp structures 4 can be made of an elastic material with good elastic restorability, e.g., an elastic metal material.

Of course, in the wiring connector according to an embodiment of this disclosure, the clamp structures 4 will not be limited to the particular structures in the respective embodiments above as long as the clamp structures 4 can clamp into the grooves 3 on the first body 11 when the second lead terminals 22 are socketed and cooperate respectively with the first lead terminals 12, so the embodiment of this disclosure will not be limited thereto.

Furthermore it shall be noted that in the wiring connector according to an embodiment of this disclosure, the first lead terminals 12 of the male joint 1 and the second lead terminals 22 of the female joint 2 can be used for a wiring of a flexible printed circuit, or a circuit lead. Particularly the first lead terminals 12 of the male joint 1 can be needles, and the second lead terminals 22 of the female joint 2 can be matching pins to be socketed with the needles; or the second lead terminals 22 of the female joint 2 can be needles, and the first lead terminals 12 of the male joint 1 can be matching pins to be socketed with the needles.

An embodiment of this disclosure further provides a flexible printed circuit which can include the wiring connector according to any one of the embodiments above of this disclosure.

An embodiment of this disclosure further provides a touch panel which can include the wiring connector according to any one of the embodiments above of this disclosure.

An embodiment of this disclosure further provides a display device which can include the wiring connector according to any one of the embodiments above of this disclosure.

Since the flexible printed circuit, the touch panel, and the display device above include the wiring connector according to any one of the embodiments above of this disclosure, they have highly reliable circuit connections therein, and not easily fail to perform their functions.

It shall be lastly noted that the foregoing embodiments are merely intended to illustrate the technical solutions according to this disclosure, but not intended to limit this disclosure thereto; and although this disclosure has been described in details in connection with the foregoing embodiments thereof, those ordinarily skilled in the art shall appreciate that they still can modify the technical solutions recited in the respective embodiments above, or make equivalent substitutions for a part of the technical features therein; and the essences of the corresponding technical solutions will not depart from the spirit and scope of the respective embodiments of this disclosure due to these modifications or substitutions.

1. A wiring connector, comprising:
a male joint comprising a first body, first lead terminals arranged on the first body, and two grooves arranged on the first body along an arrangement direction of the first lead terminals; and
a female joint comprising a second body, second lead terminals arranged on the second body, and two clamp structures installed on the second body, wherein the second lead terminals can be socketed respectively with the first lead terminals; and when the second lead terminals are socketed respectively with the first lead terminals, the two clamp structures clamp respectively into the two grooves on the first body.

2. The wiring connector according to claim 1, wherein the two grooves are arranged symmetrically on two ends of the first body.

3. The wiring connector according to claim 2, wherein each clamp structure comprises:
an extension section extending along the arrangement direction of the second lead terminals, wherein the extension section is fixed on the second body, and has a part thereof extending out of the second body; and
a clamp section fixed on one end, of the extension section, extending out of the second body, wherein the clamp section can clamp into a groove matching therewith.

4. The wiring connector according to claim 3, wherein the clamp section is a ball-head structure; a diameter of a ball head is larger than a radical size of the extension section; and the grooves are arc-shaped grooves.

5. The wiring connector according to claim 3, wherein the clamp section is a hook-shaped structure; hook-shaped sections of the two clamp structures are arranged opposite to each other; and the grooves are square-shaped or trapezoid-shaped grooves.

6. The wiring connector according to claim 1, wherein the clamp structures are integral structures.

7. The wiring connector according of claim 1, wherein the clamp structures are made of an elastic material.

8. A flexible printed circuit, comprising the wiring connector according to claim 1.

9. A touch panel, comprising the wiring connector according to claim 1.

10. A display device, comprising the wiring connector according to claim 1.
